(19) United States
(12) Patent Application Publication
(10) Pub. No.: US 2018/0347435 A1
(43) Pub. Date: Dec. 6, 2018

(54) METHOD OF EXHAUST TEMPERATURE PREDICTION

(71) Applicant: GM Global Technology Operations LLC, Detroit, MI (US)

(72) Inventors: Chao F. Daniels, Superior Township, MI (US); Rafat F. Hattar, Royal Oak, MI (US)

(21) Appl. No.: 15/611,381

(22) Filed: Jun. 1, 2017

(51) Int. Cl. F01N 11/00; G01M 15/10

(52) U.S. Cl. CPC F01N 11/005; G01M 15/102

(57) ABSTRACT

A torque requesting module generates a torque request for an engine based on driver input. A model predictive control (MPC) module: identifies sets of possible target values based on the torque request, each of the sets of possible target values including target effective throttle area percentage; determines predicted operating parameters for the sets of possible target values, respectively; determines cost values for the sets of possible target values, respectively; selects one of the sets of possible target values based on the cost values; and sets target values based on the possible target values of the selected one of the sets, respectively, the target values including a target pressure ratio across the throttle valve. A target area module determines a target opening area of the throttle valve based on the target effective throttle area percentage ratio. A throttle actuator module controls the throttle valve based on the target opening.

### FIELD

The present disclosure relates to internal combustion engines and more particularly to engine control system development for vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

When developing an engine for vehicle production, the engine must be calibrated to ensure proper operation. Part of what is considered proper operation is maintaining safe conditions for engine hardware particularly the hardware related to emissions. Each particular engine calibration is a result of testing several operation parameters by varying the parameters and collecting the results as data. The combinations of operation parameters that allow the engine to run outside of the specified temperatures, for example, are deemed unsafe for the engine hardware. Therefore, the resultant calibration will not allow the engine to operate at those particular parameters. The testing is expanded for each combination of parameters until enough data is collected for an engine map. The constant reiteration of testing each variable operation parameter results in a great deal of test time requiring expensive test facilities and man hours.

While the current method of calibrating engines is primarily successful, calibrators are required to invest hundreds of man hours and dynamometer test cell hours for data acquisition required for engine mapping. Therefore, a new method of engine calibration is necessary that is more efficient and requires less test time and hours to develop an engine calibration.

### SUMMARY

A method for estimating an exhaust temperature of an intern combustion engine comprises acquiring a current exhaust temperature for a known fuel equivalent ratio (EQR) and a known spark timing (CA50 offset), setting a normalized temperature ratio surface to the current exhaust temperature, the known EQR, and the known CA50 offset, and providing a predicted exhaust temperature produced by an alternative EQR and an alternative CA50 offset based on the normalized temperature ratio surface.

In another example of the present invention, the method includes providing an equivalent EQR that along with the known CA50 offset produces a known exhaust temperature limit based on the normalized temperature ratio surface.

In yet another example of the present invention, the method includes providing an equivalent CA50 offset that along with the known EQR produces a known exhaust temperature limit based on the normalized temperature ratio surface.

In yet another example of the present invention, acquiring a current exhaust temperature for a known EQR and a known CA50 offset further comprises acquiring a current exhaust temperature for a known fuel EQR and known CA50 wherein the known EQR is a ratio of an actual air/fuel ratio to a stoichiometric air/fuel ratio.

In yet another example of the present invention, acquiring a current exhaust temperature for a known EQR and a known CA50 offset further comprises acquiring a current exhaust temperature for a known fuel EQR and known CA50 wherein the known CA50 offset is a number of crankshaft degrees from a crankshaft position at which 50% of an air/fuel mass is combusted.

In yet another example of the present invention, setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda, the normalized temperature ratio surface (Z(I,J)) is defined by the following equations:

Y(J)=A*Lambda³+B*Lambda²+C*Lambda+D

Z(I,J)=Y(J)*(E*CA50²+F*CA50+G), and

A, B, C, D, E, F, and G are constants specific to the engine.

In yet another example of the present invention, setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda and the normalized temperature ratio surface (Z(I,J)) is defined by the following equations:

Y(J)=−5.1666*Lambda³+12.307*Lambda²−9.0429*Lambda+2.901

Z(I,J)=Y(J)*(1e⁻⁴*CA50²+0.0048*CA50+1.0005).

In yet another example of the present invention, setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the normalized temperature ratio is a ratio of a current exhaust temperature to an exhaust temperature when EQR=1 and CA50=8.5°.

Further objects, aspects and advantages of the present invention will become apparent by reference to the following description and appended drawings wherein like reference numbers refer to the same component, element or feature.

### BRIEF DESCRIPTION OF THE DRAWINGS

The present disclosure will become more fully understood from the detailed description and the accompanying drawings, wherein:

FIG. 1 is a functional block diagram of an example engine system according to the present disclosure;

FIG. 2 is a three axis graph depicting a normalized temperature surface as a function of fuel ratio and spark ignition timing; and

FIG. 3 is a functional block diagram of a method of calibrating an engine system according to the present disclosure.

### DETAILED DESCRIPTION

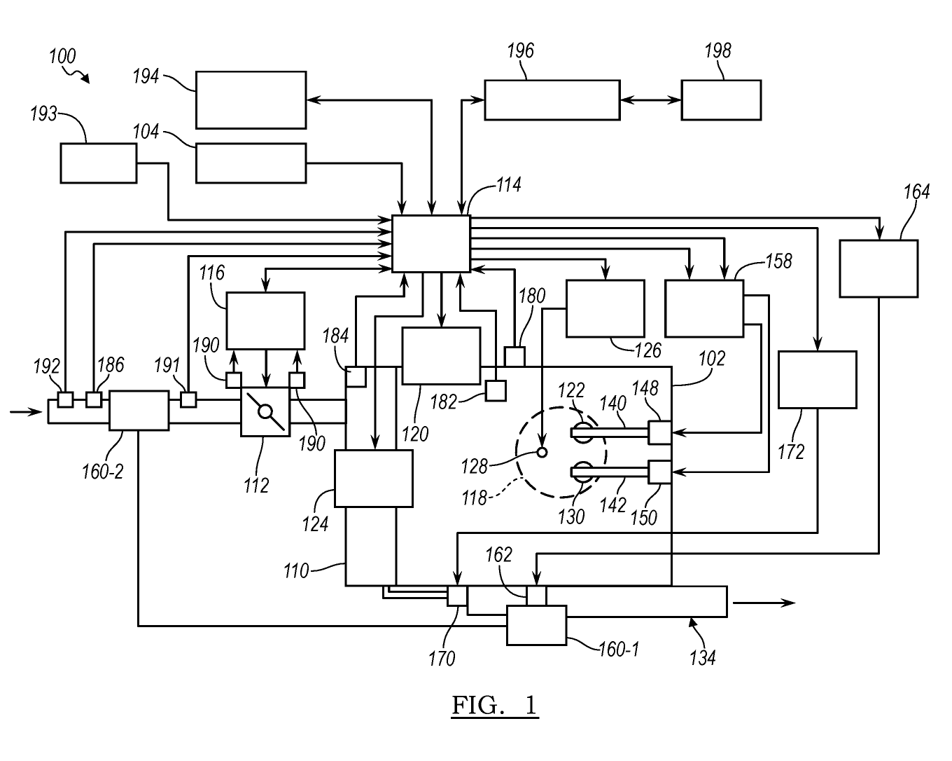

Referring now to FIG. 1, a functional block diagram of an example engine system 100 is presented. The engine system 100 includes an engine 102 that combusts an air/fuel mixture to produce drive torque for a vehicle based on driver input from a driver input module 104. The engine 102 may be a gasoline spark ignition internal combustion engine.

Air is drawn into an intake manifold 110 through a throttle valve 112. For example only, the throttle valve 112 may include a butterfly valve having a rotatable blade. An engine control module (ECM) includes software programs for controlling engine operations based on driver and sensor input. The ECM 114 controls a throttle actuator module 116, which regulates opening of the throttle valve 112 to control the amount of air drawn into the intake manifold 110. The software programs of the ECM 114 include logic code written by engine calibrators. The logic code is the decision making algorithms that receive input from the several sensors on the engine, transmission, and vehicle and communicate operation signals to the various actuators that control the powertrain operation.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders, which may improve fuel economy under certain engine operating conditions.

The engine 102 may operate using a four-stroke cycle. The four strokes, described below, may be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a target air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. A spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. Generating spark may be referred to as a firing event. The spark actuator module 126 may have the ability to vary the timing of the spark for each firing event. The spark actuator module 126 may vary the spark timing for a next firing event when the spark timing is changed between a last firing event and the next firing event. The spark actuator module 126 may halt provision of spark to deactivated cylinders.

During the combustion stroke, the combustion of the air/fuel mixture drives the piston away from TDC, thereby driving the crankshaft. The combustion stroke may be defined as the time between the piston reaching TDC and the time at which the piston reaches bottom dead center (BDC). During the exhaust stroke, the piston begins moving away from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). In various other implementations, the intake valve 122 and/or the exhaust valve 130 may be controlled by devices other than camshafts, such as camless valve actuators. The cylinder actuator module 120 may deactivate the cylinder 118 by disabling opening of the intake valve 122 and/or the exhaust valve 130.

The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158.

The engine system 100 may include a turbocharger that includes a hot turbine 160-1 that is powered by hot exhaust gases flowing through the exhaust system 134. The turbocharger also includes a cold air compressor 160-2 that is driven by the turbine 160-1. The compressor 160-2 compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) provided by the turbocharger. A boost actuator module 164 may control the boost of the turbocharger by controlling opening of the wastegate 162. In various implementations, two or more turbochargers may be implemented and may be controlled by the boost actuator module 164.

An air cooler (not shown) may transfer heat from the compressed air charge to a cooling medium, such as engine coolant or air. An air cooler that cools the compressed air charge using engine coolant may be referred to as an intercooler. An air cooler that cools the compressed air charge using air may be referred to as a charge air cooler. The compressed air charge may receive heat, for example, via compression and/or from components of the exhaust system 134. Although shown separated for purposes of illustration, the turbine 160-1 and the compressor 160-2 may be attached to each other, placing intake air in close proximity to hot exhaust.

The engine system 100 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172 based on signals from the ECM 114.

A position of the crankshaft may be measured using a crankshaft position sensor 180. A rotational speed of the crankshaft (an engine speed) may be determined based on the crankshaft position. A temperature of the engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. A pressure of air input to the throttle valve 112 may be measured using a throttle inlet air pressure (TIAP) sensor 191. An ambient temperature of air being drawn into the engine 102 may be measured using an intake air temperature (IAT) sensor 192. The engine system 100 may also include one or more other sensors 193, such as an ambient humidity sensor, one or more knock sensors, a compressor outlet pressure sensor and/or a throttle inlet pressure sensor, a wastegate position sensor, an EGR position sensor, and/or one or more other suitable sensors. The ECM 114 may use signals from the sensors to make control decisions for the engine system 100.

The ECM 114 may communicate with a transmission control module 194 to coordinate shifting gears in a transmission (not shown). For example, the ECM 114 may reduce engine torque during a gear shift. The ECM 114 may communicate with a hybrid control module 196 to coordinate operation of the engine 102 and an electric motor 198.

The electric motor 198 may also function as a generator, and may be used to produce electrical energy for use by vehicle electrical systems and/or for storage in a battery. In various implementations, various functions of the ECM 114, the transmission control module 194, and the hybrid control module 196 may be integrated into one or more modules.

Each system that varies an engine parameter may be referred to as an engine actuator. For example, the throttle actuator module 116 may adjust opening of the throttle valve 112 to achieve a target throttle opening area. The spark actuator module 126 controls the spark plug ignition to achieve a target spark timing relative to piston TDC. The fuel actuator module 124 controls the fuel injectors to achieve target fueling parameters. The phaser actuator module 158 may control the intake and exhaust cam phasers 148 and 150 to achieve target intake and exhaust cam maximum opening positions, respectively. The boost actuator module 164 controls the wastegate 162 to achieve a target wastegate opening area. The cylinder actuator module 120 controls cylinder deactivation to achieve a target number of activated or deactivated cylinders.

One of the many tasks assigned to a calibration of the vehicle powertrain is to protect the powertrain hardware from damage. One example of protecting an engine through calibration is utilizing an engine speed limiter to keep the engine from spinning too fast. The engine speed limiter works by cutting fuel and/or spark ignition to the engine when a particular RPM is reached.

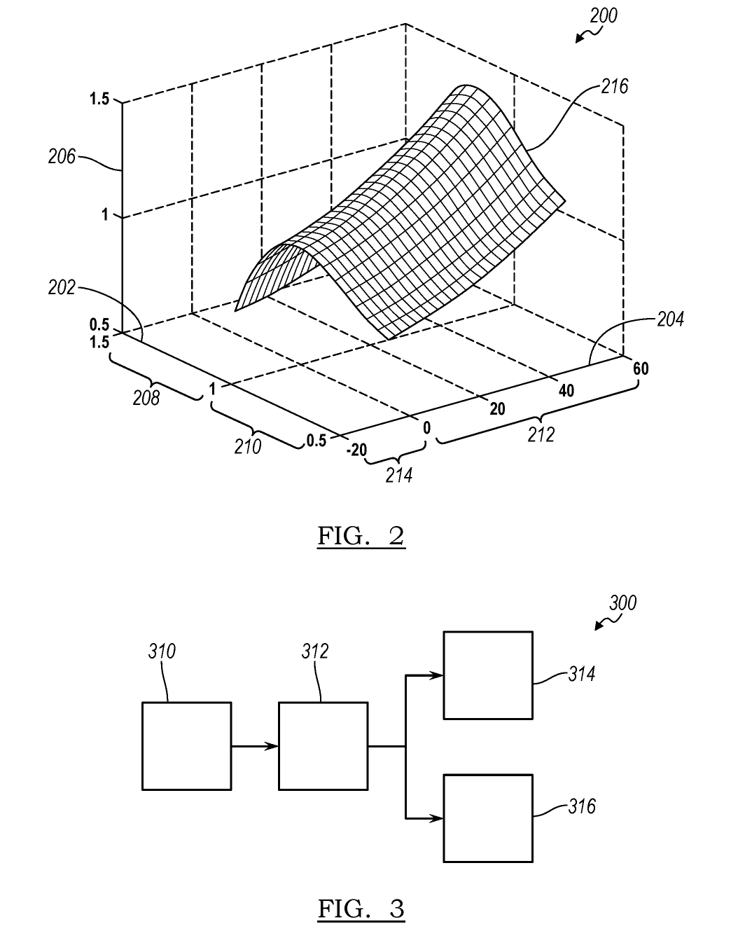

Another example of protecting engine hardware is limiting the temperature at which the engine hardware operates. Turning now to FIG. 2, a graph 200 of the relationship between two engine operating parameters and the temperature of the collection area of the exhaust manifold. The particular engine operating parameters or actuators of prominence here are the spark actuator module 126 and the fuel actuator module 124. The control logic that the powertrain calibrators program includes manipulation of a fuel parameter, the fuel equivalence ratio (EQR), and a spark ignition timing parameter CA50 (the angle of the crankshaft at which half of the combustible air/fuel mass is burned in the cylinder) 204. EQR is used to control the amount of fuel that is injected into the intake manifold or cylinder by the fuel injectors. The EQR is the ratio of the actual amount of fuel injected to the amount of fuel required for stoichiometric combustion. An EQR that is greater than 1 indicates a fuel rich air/fuel mixture. If the EQR is less than 1, the air/fuel mixture is lean. In terms of the effect on exhaust temperature ratio 206, each of the lean and rich EQR has a reducing effect on exhaust temperature ratio 206 albeit for different reasons. A rich EQR burns all the fuel injected in the cylinder to the point that the oxygen runs out. The remaining unburnt fuel is exhausted with the burnt gases to the exhaust manifold. The unburnt fuel then has a cooling effect on the exhaust manifold and catalyst. A lean EQR, while burning all the fuel injected into the cylinder, simply does not burn as much fuel as when the EQR is 1 and therefore has reduced temperatures and pressures of the gases exhausting from the cylinder into the exhaust manifold and catalyst.

Additionally, a spark timing parameter is adjusted by calibrators to achieve particular performance outcomes. The spark timing parameter CA50 offset 204 is the number of degrees of advanced or retarded spark from CA50. For example, retarding spark ignition 10° delays combustion compared to the rotational position of the crankshaft and therefore the position of the piston in the cylinder 118 and of the exhaust valve 130. The delay in spark ignition delays the combustion event such that less of the fuel/air mass is burning in the cylinder and more of the fuel/air mass is burning as the mixture leaves the cylinder through the exhaust port and into the exhaust manifold. As a result, retarding spark 212 for the most part increases the temperature of the exhaust manifold and catalyst due to the progressively increasing pressure and temperature of the mass combusting while it goes through the exhaust manifold 134. Alternatively, advancing spark 214 results in more of the combustion occurring within the cylinder and therefore lower exhaust temperatures.

The graph 200 includes a normalized temperature surface 216 for calibrating safe exhaust temperature ratio 206 for a particular variable Lambda 202 and CA50 offset 204 parameters. The vertical axis 206 is a temperature ratio which is defined as a ratio of a current exhaust temperature to an exhaust temperature when EQR=1 and CA50=8.5°. Therefore, when the current exhaust temperature is greater than the exhaust temperature when EQR=1 and CA50=8.5° then the temperature ratio is greater than 1. Likewise, when the current exhaust temperature is less than the exhaust temperature when EQR=1 and CA50=8.5° then the temperature ratio is less than 1.

The value on a first horizontal axis is for Lambda 202. Lambda 202 is the inverse of EQR. Therefore, a lean air/fuel ratio 208 will have a lambda 202 value greater than 1. A rich air/fuel ratio 210 will have a lambda 202 value less than 1.

The value displayed in the graph 200 on the second horizontal axis is CA50 204 which is the degrees of spark timing offset from 8.5°. Values greater than zero represent spark retard while values less than zero represent spark advance.

The normalized temperature surface 216 is derived from a formulated equation as shown:

Y(J)=A*Lambda³+B*Lambda²+C*Lambda+D

Z(I,J)=Y(J)*(E*CA50²+F*CA50+G)

Where A, B, C, D, E, F, and G are constants that are derived from engine testing and are specific to a particular engine configuration. For example, the constants used to derive the normalized temperature surface 216 shown in FIG. 2 are as follows:
A=−5.1666
B=12.3070
C=−9.0429
D=2.9010
E=1e⁻⁴
F=0.0048
G=1.0005
   Whereas these constants are applicable to many different engines, a minimal amount of testing is required to more precisely calibrate the constants for some engine applications.

Turning now to FIG. 3 with continuing reference to FIG. 2, a method for calibrating an engine for exhaust temperature protection is depicted and will now be described. The method 300 begins with a first step 310 of collecting a data point of a current exhaust temperature for a known EQR 202 and a known CA50 offset 204. A second step 312 includes applying the data point of the first step 310 to the normalized temperature surface 216. From the second step 312, the method 300 continues to a third step 314 of predicting the exhaust temperature under a new set of EQR 202 and CA50 offset 204 parameters. Additionally, the method 300 can continue to a fourth step 314 predicting an EQR 202 given a known CA50 offset 204 and a known exhaust temperature limit or predicting CA50 offset 204 given a known EQR 202 and a known exhaust temperature limit.

The foregoing description of the invention is merely exemplary in nature and variations that do not depart from the gist of the invention are and are intended to be within the scope of the invention. Such variations are not to be regarded as a departure from the spirit and scope of the invention and the following claims.

We claim:

1. A method for estimating an exhaust temperature of an intern combustion engine, the method comprising:
acquiring a current exhaust temperature for a known fuel equivalent ratio (EQR) and a known spark timing (CA50 offset);
setting a normalized temperature ratio surface to the current exhaust temperature, the known EQR, and the known CA50 offset, and
providing a predicted exhaust temperature produced by an alternative EQR and an alternative CA50 offset based on the normalized temperature ratio surface.

2. The method of claim 1 further comprises providing an equivalent EQR that along with the known CA50 offset produces a known exhaust temperature limit based on the normalized temperature ratio surface.

3. The method of claim 1 further comprises providing an equivalent CA50 offset that along with the known EQR produces a known exhaust temperature limit based on the normalized temperature ratio surface.

4. The method of claim 1 wherein acquiring a current exhaust temperature for a known EQR and a known CA50 offset further comprises acquiring a current exhaust temperature for a known fuel EQR and known CA50 wherein the known EQR is a ratio of an actual air/fuel ratio to a stoichiometric air/fuel ratio.

5. The method of claim 1 wherein acquiring a current exhaust temperature for a known EQR and a known CA50 offset further comprises acquiring a current exhaust temperature for a known fuel EQR and known CA50 wherein the known CA50 offset is a number of crankshaft degrees from a crankshaft position at which 50% of an air/fuel mass is combusted.

6. The method of claim 1 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda, the normalized temperature ratio surface (Z(I,J)) is defined by an equation as follows:
Y(J)=A*Lambda³+B*Lambda²+C*Lambda+D
Z(I,J)=Y(J)*(E*CA50²+F*CA50+G), and
A, B, C, D, E, F, and G are constants specific to the engine.

7. The method of claim 1 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda and the normalized temperature ratio surface (Z(I,J)) is defined by an equation as follows:
Y(J)=−5.1666*Lambda³+12.307*Lambda²−9.0429*Lambda+2.901
Z(I,J)=Y(J)*(1e⁻⁴*CA50²+0.0048*CA50+1.0005).

8. The method of claim 1 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the normalized temperature ratio is a ratio of a current exhaust temperature to an exhaust temperature when EQR=1 and CA50=8.5°.

9. A method for estimating an exhaust temperature of an internal combustion engine, the method comprising:
acquiring a current exhaust temperature for a known fuel equivalent ratio (EQR) and a known spark timing (CA50 offset);
setting a normalized temperature ratio surface to the current exhaust temperature, the known EQR, and the known CA50 offset;
providing a predicted exhaust temperature produced by an alternative EQR and an alternative CA50 offset based on the normalized temperature ratio surface;
providing an equivalent EQR that along with the known CA50 offset produces a known exhaust temperature limit based on the normalized temperature ratio surface, and
providing an equivalent CA50 offset that along with the known EQR produces a known exhaust temperature limit based on the normalized temperature ratio surface.

10. The method of claim 9 wherein acquiring a current exhaust temperature for a known EQR and a known CA50 offset further comprises acquiring a current exhaust temperature for a known fuel EQR and known CA50 wherein the known EQR is a ratio of an actual air/fuel ratio to a stoichiometric air/fuel ratio.

11. The method of claim 9 wherein acquiring a current exhaust temperature for a known EQR and a known CA50 offset further comprises acquiring a current exhaust temperature for a known fuel EQR and known CA50 wherein the known CA50 offset is a number of crankshaft degrees from a crankshaft position at which 50% of an air/fuel mass is combusted.

12. The method of claim 9 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda, the normalized temperature ratio surface (Z(I,J)) is defined by an equation as follows:
Y(J)=A*Lambda³+B*Lambda²+C*Lambda+D
Z(I,J)=Y(J)*(E*CA50²+F*CA50+G), and
A, B, C, D, E, F, and G are constants specific to the engine.

13. The method of claim 9 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the known EQR is the inverse of Lambda and the normalized temperature ratio surface (Z(I,J)) is defined by an equation as follows:
Y(J)=−5.1666*Lambda³+12.307*Lambda²−9.0429*Lambda+2.901
Z(I,J)=Y(J)*(1e⁻⁴*CA50²+0.0048*CA50+1.0005).

14. The method of claim 9 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the normalized temperature ratio is a ratio of a current exhaust temperature to an exhaust temperature when EQR=1 and CA50=8.5°.

15. A method for estimating an exhaust temperature of an intern combustion engine, the method comprising:
acquiring a current exhaust temperature for a known fuel equivalent ratio (EQR) and a known spark timing (CA50 offset);
setting a normalized temperature ratio surface to the current exhaust temperature, the known EQR, and the known CA50 offset, and wherein the known EQR is the inverse of Lambda, the normalized temperature ratio surface (Z(I,J)) is defined by an equation as follows:
Y(J)=A*Lambda³+B*Lambda²+C*Lambda+D
Z(I,J)=Y(J)*(E*CA50²+F*CA50+G), and
A, B, C, D, E, F, and G are constants;
providing a predicted exhaust temperature produced by an alternative EQR and an alternative CA50 offset based on the normalized temperature ratio surface, and
providing an equivalent EQR that along with the known CA50 offset produces a known exhaust temperature limit based on the normalized temperature ratio surface.

16. The method of claim 15 further comprises providing an equivalent CA50 offset that along with the known EQR produces a known exhaust temperature limit based on the normalized temperature ratio surface.

17. The method of claim 15 wherein acquiring a current exhaust temperature for a known EQR and a known CA50 offset further comprises acquiring a current exhaust temperature for a known fuel EQR and known CA50 wherein the known EQR is a ratio of an actual air/fuel ratio to a stoichiometric air/fuel ratio.

18. The method of claim 15 wherein acquiring a current exhaust temperature for a known EQR and a known CA50 offset further comprises acquiring a current exhaust temperature for a known fuel EQR and known CA50 wherein the known CA50 offset is a number of crankshaft degrees from a crankshaft position at which 50% of an air/fuel mass is combusted.

19. The method of claim 18 wherein setting a normalized temperature ratio surface to the current exhaust temperature, the known EQR, and the known CA50 offset, and wherein the known EQR is the inverse of Lambda, the normalized temperature ratio surface (Z(I,J)) is defined by an equation as follows:
Y(J)=A*Lambda³+B*Lambda²+C*Lambda+D
Z(I,J)=Y(J)*(E*CA50²+F*CA50+G), and
A, B, C, D, E, F, and G are constants specific to an engine further comprises setting a normalized temperature ratio surface to the current exhaust temperature, the known EQR, and the known CA50 offset, and wherein the known EQR is the inverse of Lambda and the normalized temperature ratio surface (Z(I,J)) is defined by an equation as follows:
Y(J)=−5.1666*Lambda³+12.307*Lambda²−9.0429*Lambda+2.901
Z(I,J)=Y(J)*(1e⁻⁴*CA50²+0.0048*CA50+1.0005).

20. The method of claim 15 wherein setting a normalized temperature ratio surface to the current exhaust temperature, the known EQR, and the known CA50 offset further comprises setting a normalized temperature ratio surface to the current exhaust temperature, the known EQR, and the known CA50 offset, and wherein the normalized temperature ratio is a ratio of a current exhaust temperature to an exhaust temperature when EQR=1 and CA50=8.5°.
